(19) United States
(12) Patent Application Publication
(10) Pub. No.: US 2017/0109793 A1
(43) Pub. Date: Apr. 20, 2017

(54) E-CHECK DEVICE, SYSTEM AND A METHOD THEREOF

(71) Applicants: Ian BERRY, Tampa, FL (US); Gavin BERRY, Tampa, FL (US)

(72) Inventors: Ian BERRY, Tampa, FL (US); Gavin BERRY, Tampa, FL (US)

(21) Appl. No.: 15/267,034

(22) Filed: Sep. 15, 2016

Related U.S. Application Data
(63) Continuation of application No. 13/931,289, filed on Jun. 28, 2013, now abandoned.
(60) Provisional application No. 61/666,528, filed on Jun. 29, 2012.

(51) Int. Cl. G06Q 30/02; G06Q 30/06; G06Q 20/20

(52) U.S. Cl. CPC G06Q 30/0268; G06Q 20/204; G06Q 30/0633; G06Q 30/0641

(57) ABSTRACT

Discussed herein is an electronic device, electronic system and a method of use and applications thereof. The electronic device provides a mechanism of making payment transactions in a seamless manner. Further, the electronic device avoids delays in processing payment transactions, which otherwise may cause an unpleasant experience. The electronic system provides for integration with frequent diner accounts, ability to monitor different transactions in real-time and provides an enhanced dining experience thereby increasing the overall productivity of the system,

### CROSS-REFERENCE TO RELATED APPLICATIONS

This application is a continuation of U.S. patent application Ser. No. 13/931,289 filed Jun. 28, 2013, and is based upon and claims the benefit of priority under 35 U.S.C. §120 from, the prior Provisional U.S. patent application Ser. No. 61/666,528, filed on Jun. 29, 2012, the entire contents of each of which are herein incorporated by reference.

### FIELD

The present invention relates to an E-check device, an E-check system, methods of use and applications thereof. More particularly, embodiments of the present invention relate to an E-check device wherein a customer can make a payment for services received in a seamless and hassle free manner.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Upon receiving services, payments are generally made with the use of a credit card, gift-card or the like. Processing the credit card of a customer by a proprietor usually incurs delay and may in certain situations provide an unpleasant experience for the customer. For example, usually while dining at a restaurant, the customer may make the payment for his meal with the use of a credit card. This process usually requires the customer to wait until the attendant is free to serve him, ask the attendant to bring him/her the check, wait until the attendant processes his card and brings him a receipt of the transaction. Further, during busy hours of operation, the customer may incur additional delays. Similar delays can be incurred even if the customer is making a cash payment for his meal.

Accordingly, there is a desire to minimize the wait time of a customer to complete his transaction and make the customer's experience a pleasant one.

### BRIEF DESCRIPTION OF THE DRAWINGS

A more complete appreciation of the disclosed embodiments and many of the attendant advantages thereof will be readily obtained as the same becomes better understood by reference to the following detailed description when considered in connection with the accompanying drawings, wherein:

FIG. 1 illustrates schematically an exemplary E-Check device;

FIG. 2 illustrates an exemplary block diagram depicting a sequence of displays on the E-check device when operated in the first mode;

FIG. 3 illustrates an exemplary block diagram depicting a sequence of displays on the E-check device when operated in the second mode;

FIG. 4 illustrates according to another example, the information displayed on the E-check device;

FIG. 5 illustrates according to an example, a detailed view of a table page of a particular attendant;

FIGS. 6A-6G illustrate an example of information displayed on the E-check device for customer checkout;

FIGS. 7A-7E illustrate information displayed on the E-check device corresponding to printing a receipt of a bill and a conducting a survey by the customer;

FIG. 8 depicts a diagrammatic representation of an E-check restaurant system;

FIG. 9 is a flowchart illustrating an exemplary process of using the E-check device in the restaurant system of FIG. 8;

FIG. 10 is an exemplary flowchart depicting a customization of a user's dining experience; and

FIG. 11 is an exemplary controller that may be used to control any E-check or E-menu device.

### DETAILED DESCRIPTION

Embodiments disclosed herein relate to an E-check device, E-check system, and a method of using the E-check device. The E-check device, system, and the method of using the E-check device will be described in the context of a restaurant setting. However, be appreciated that the E-check device can also be used in several other businesses, in a manner as described below.

Embodiments disclosed herein provide for a method of providing an enhanced dining experience by using an electronic device, the method comprising: receiving a listing of charges for a user, the listing including a description of the charges; determining suggested additional products for purchase; displaying the suggested additional products to the user; receiving a purchase selection of the additional products from the user; updating the listing of charges based on the selected additional products; displaying a plurality of options to pay for the charges; receiving a selection of an option of the received plurality of payment options; and transferring payment information from the electronic device to a processing server to complete a payment transaction.

According to another embodiment of the method, the listing further includes a link to a detailed description of the charges.

According to another embodiment of the method, the method further comprises performing a login operation at the electronic device; receiving a plurality of dining options available for ordering; providing suggestions from the plurality of dining options based upon a user profile of the logged in user; receiving a selection of a dining option from the user; and transmitting the dining selection to a central server.

According to another embodiment of the method, the method further comprises receiving a selection of an attendant to serve the dining order.

According to another embodiment of the method, the method further comprises receiving an estimated wait time for delivering the transmitted dining selection.

According to another embodiment of the method, the suggested additional products for purchase include merchandise.

According to another embodiment of the method, the suggested additional products for purchase include any menu item.

According to another embodiment of the method, the method further comprises offering the option of completing a survey after displaying the plurality of options to pay for the charges.

According to another embodiment of the method, the method further comprises transmitting a request for printing a receipt of the payment information,

According to another embodiment of the method, the method further comprises transmitting, by a GPS transmitter, a location of the electronic device to the central server,

Embodiments disclosed herein further provide for a method of providing an enhanced dining experience by a central server, the central server implementing the method comprising: receiving login information from an electronic device; obtaining profile information of a user based on the login information; recommending meal preferences for the user based on the profile information; receiving a dining order from the electronic device; estimating a wait time for fulfillment of the dining order; notifying an attendant to serve the dining order when it is ready; providing a plurality of payment options to the electronic device; and receiving and processing payment information transmitted from the electronic device.

According to another embodiment of the method, the method further comprises determining whether the received dining order can be completed based on an inventory stock or whether the customized menu can be implemented; and updating the inventory stock upon receiving the plurality of dining orders from the electronic devices.

According to another embodiment of the method, the method further comprises offering products or services at a discounted rate in response to a wait time exceeding a predetermined threshold.

According to another embodiment of the method, the method further comprises tracking the location of the electronic device.

According to another embodiment of the method, the method further comprises providing a plurality of shopping items for electronic device; transmitting a survey to the electronic device; and providing a plurality of options for transmitting a receipt of the payment information.

According to another embodiment of the method, the method further comprises storing dining order information in a memory; and processing the stored information to determine popularity of a certain dining item.

Embodiments described herein provide for an electronic device comprising: a display panel configured to display information; a payment reader configured to capture payment information; an input element configured to receive user input; a memory; and a processor configured to implement: a display unit configured to display on the display panel a login screen, a menu screen including ordering options, and a payment screen including payment options, a reception unit configured to receive order information and receive input login information, a payment unit configured to receive payment information captured by the payment reader, and a transmission unit configured to transmit the received order information, the login information, and the payment information central server. According to another embodiment of the electronic device, the central server is configured to verify login information received from the electronic device, determine dining recommendations based on a user profile corresponding to the login information, receive a dining order from the electronic device, estimate a wait time for delivering the received dining order, provide a plurality of payment options to the electronic device, and receive payment information transmitted from each electronic device.

Embodiments described herein also provide for an electronic device comprising a display panel configured to display information; a payment reader configured to capture payment information; an input element configured to receive user input; a communication element configured to communicate with a central server; a memory; and a processor configured to: receive a listing of charges for a user, the listing including a description of the charges; determine suggested additional products for purchase; display on the display panel the suggested additional products to the user; receive via the input element a purchase selection of the additional products from the user; update the listing of charges based on the selected additional products; display on the display panel a plurality of options to pay for the charges; receive via the input element a selection of an option of the received plurality of payment options; and transfer via the communication element payment information from the electronic device to a processing server to complete a payment transaction.

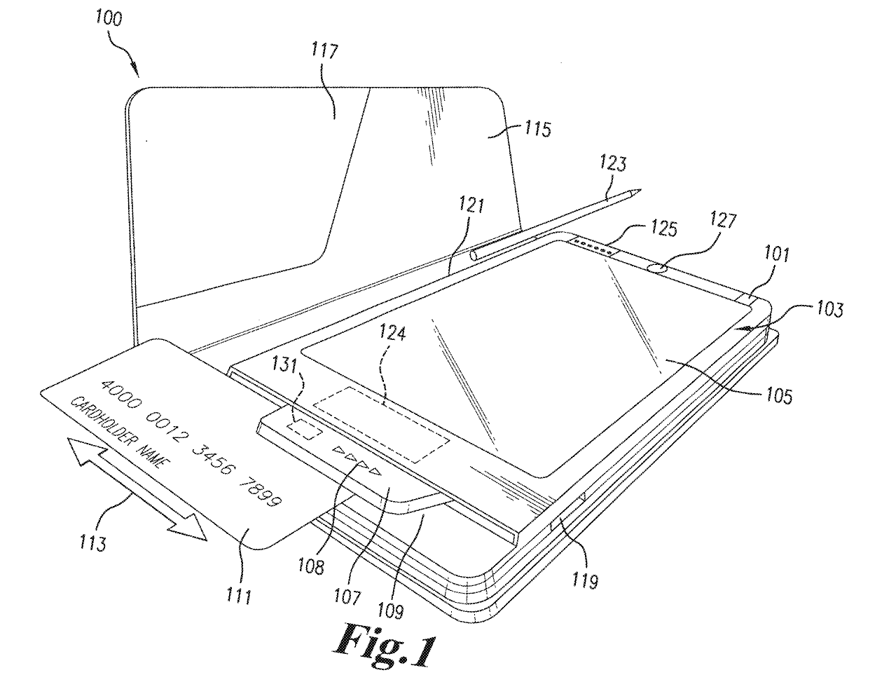

Turning to FIG. 1, there is illustrated an exemplary E-check device 100 according to one embodiment. The E-check device 100 includes a power ON/OFF switch 101, a display 103, a touch panel 105, an electronic card reader 107, a microphone 125, a stylus 123, an input port 119, and an outer case 115.

The display 103 may be, for example, a liquid crystal display (LCD) panel, an organic electroluminescent (OLED) display panel, a plasma display panel, or the like. The display 103 may display text, an image, a web page, a video, or the like. For example, when the E-check device 100 connects with the Internet, the display 103 may display text and/or image data which is transmitted from a web server in a predetermined format such as Hyper Text Markup Language (HTML) format or XML and displayed via a web browser. The display panel 103 may additionally display data stored in a memory unit.

The E-check device 100 may include a touch panel 105 that can detect a touch operation on the surface of the display 103. For example, the touch panel 105 can detect a touch operation performed by an instruction object such as a finger or a stylus 123. The stylus 123 can be placed in a groove 121, adjacent to the display. Touch operations may correspond to a user's input such as a selection of an icon that is displayed on the display 103. The touch panel 105 may be an electrostatic capacitance type device, a resistive type touch panel device or other such type of devices that are used for detecting a touch on the display panel.

The touch panel 105 may perform processing related to touch operation classification. For example, the touch panel 105 may assign a predetermined function to be performed when a tap operation is detected. Similarly, the touch panel may analyze a touch operation wherein the instruction object makes continuous contact with the display while moving the instruction object around the display, for example a swipe or a drag operation. The touch panel 105 may output a signal based on a classification of the touch operation performed. The signal may, for example, include information indicating the touch operation classification, the location on the display, where the touch operation was performed and the operation to be performed based on the touch operation. Further, the touch panel 105 may be created by adding a transparent surface to a touch sensitive graphics digitizer and sizing the digitizer to fit the display 103.

Incorporated in the E-check device is an electronic card reader 107, such as a magnetic reader, which includes a plurality of LED indicators 108, which are configured to light, so as to provide a visual indication to a user to swipe a credit card. The card reader has one or more magnetic read/write heads and may be of the kind used in a magnetic card reader machine. Thus, the reader has solenoids and/or any other mechanism known in the art to read and write data from and to a magnetic strip (tape) on a credit card. The electronic card reader 107 is very compact so as to not overly increase the size and bulkiness of the device 100.

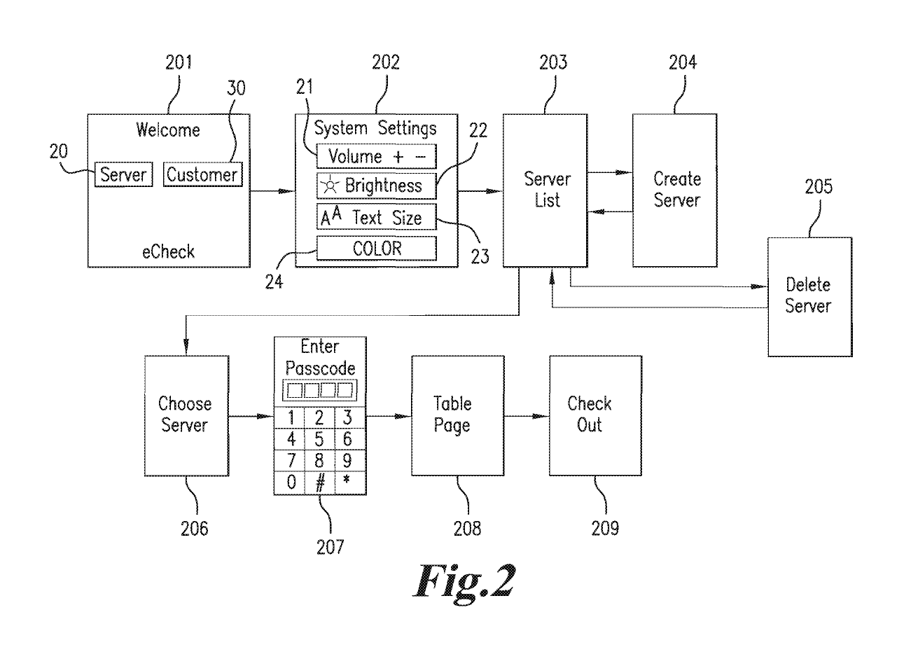

Further, not necessary that the electronic card reader be located at the specific position on the E-check device 100 shown in FIG. 2. The electronic card reader may also be located on any side of the E-check device 100, such that the reader is able to interact electromagnetically, that is, read data from and/or write data to a magnetic strip of a standard width credit card. Further, the credit card 111 can be swiped in a slot (slit) 109 in a direction as indicated 113. Similarly, the stylus 123 need not be placed necessarily in the groove 121 adjacent to the display as shown in FIG. 1. For example, the stylus can be placed in a dedicated chamber embedded in the E-check device, or alternatively, the stylus can be placed in a holder that s attached to the E-check device.

The outer case 115 of the E-check device 100 can be generally comprised of a felt-like material to protect the touch panel 105 of the E-Check device. Further, the outer case may include a sleeve 117, which can be used to hold business cards, credit cards, etc, of the customer. The E-check device also includes a microphone 125 that can be used to accept voice commands to operate the E-check device 100, for example the customer may place a meal order by simply reading out the food items he desires. Further, an input port 119 is included which can be used to transfer information to and from the E-check device to other devices. The input port can be of standard USB type, micro-USB type port or the like and can also be used to charge the E-check device. Alternatively, the E-check device 100, may include a dedicated power port that is used to charge (power up) the E-check device.

The E-check device may also include a NFC contactless card reader 124 which can be used to capture credit card information in a seamless manner. The NFC card reader 124 can be any standard NFC reader based on REID technology and compliant with ISO/IEC18092 standard for near field communications. Credit card information may be transmitted by holding the card in close proximity of the NFC reader. The NFC card reader can be implemented as a software application that is executed by a processing unit of the E-check device 100. Further, the NFC reader may be displayed as an icon on the display of the E-check device, wherein upon activation by the customer the E-check device may instruct the customer to position his card near the display of the E-check device.

Furthermore, the E-check device can include an EMV reader 131, for authenticating credit and debit card transactions. According to one embodiment, instead of swiping the card through the electronic card reader 107, an alternative form of making payments using the EMV reader is provided by the E-check device. Specifically, an EMV compatible card can be inserted in the slot in the EMV reader so that payment information can be processed by the EMV reader 131.

The E-check device 100 can be configured to accept credit card payments from credit cards such as Visa, MasterCard, American Express, Discover or the like. The E-check device can be PCI compliant and implement a SSL encryption technique. The E-check device can also be EuroPay, MasterCard and Visa (EMV) approved, which is a global standard for inter-operation of integrated circuit cards (IC cards or “chip cards”) and IC card capable point of sale (POS) terminals for authenticating credit and debit card transactions.

The E-check device 100 may also include a GPS tracker 127 which is used to determine the precise location of the E-check device. The recorded location data can be stored within a tracking unit of the E-check device 100, or it may be transmitted to a central location data base, or internet-connected computer, sing a cellular (GPRS or SMS), radio, or satellite modem embedded in the E-check device. This feature provisions for the E-check device's location to be displayed against a map backdrop either in real time or when analyzing the track later, using GPS tracking software.

It must be appreciated that the above described features of the E-check device are in no way limiting the scope of the present invention. Various modifications and inclusion of the features may be adopted to perform the desired function without departing from the spirit of the invention.

The E-check device of FIG. 1 can be used in two modes of operation in the restaurant setting. In the first mode of operation, the device can be operated by an attendant and in the second mode of operation the device can be operated by a customer. Further, according to one embodiment, the E-check device while being operated by the customer, may communicate in different manners to the E-check device operated by the attendant.

FIG. 2 illustrates an exemplary block diagram depicting a sequence of displays on the E-check device when operated in the first mode.

In 201, a welcome message is displayed along with two icons 20 and 30 representing an attendant mode and a customer mode respectively. Upon selecting a mode (in this case, the attendant mode) by using a touch operation, the display changes to the display as shown in 202.

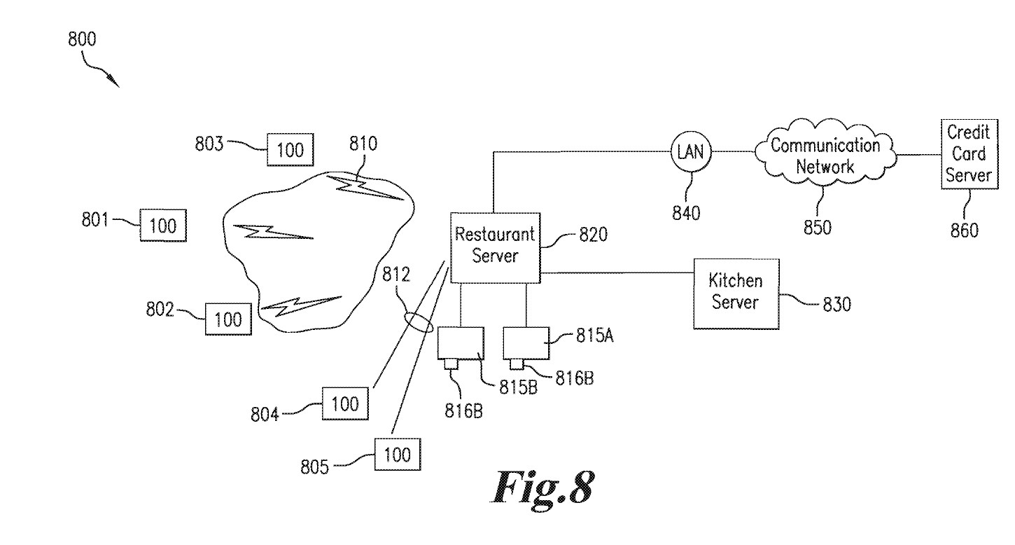

In 202, the system settings such as volume, brightness, text size, and color are displayed as shown by 21-24 respectively. According to an embodiment, the attendant can manually configure the settings of the E-check device as per his/her requirements. According to another embodiment, the display settings of the E-check device 100 may be controlled by a centralized server such as a restaurant processing server, which is explained later with reference to FIG. 8.

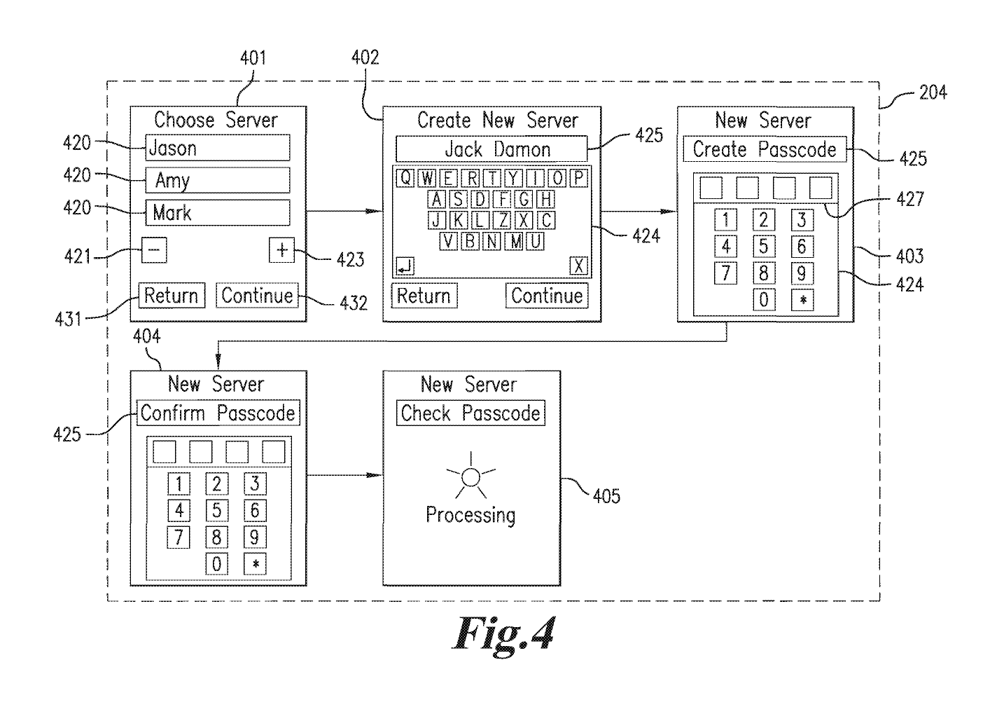

In 203, an attendant list is displayed, which subsequently provides an option for creating, deleting, and choosing a particular attendant. The displays corresponding to these options are referenced as 203-206 in FIG. 2. The specific details of these displays are described later with reference to FIG. 4.

In 207, an ‘enter passcode’ message is displayed on the screen along with a keypad 26 and a password block 25, wherein the password is entered by the attendant. The passcode allows the E-check device to ensure that access to the E-check system is granted to the intended attendant.

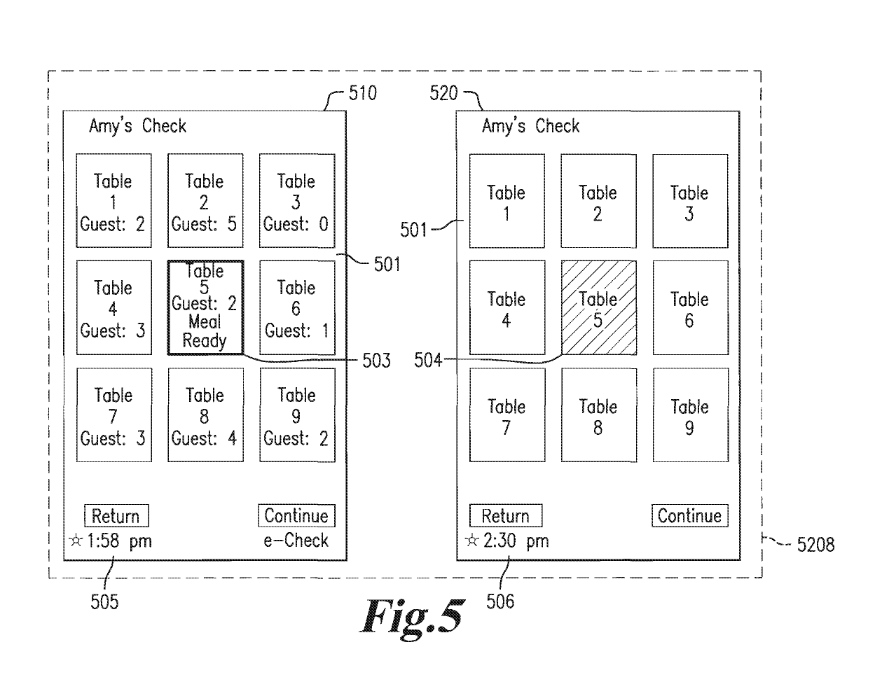

Further, in 208, upon successful entry of a passcode, the corresponding tables managed by the attendant are displayed. The table display is explained in detail later with reference to FIG. 5.

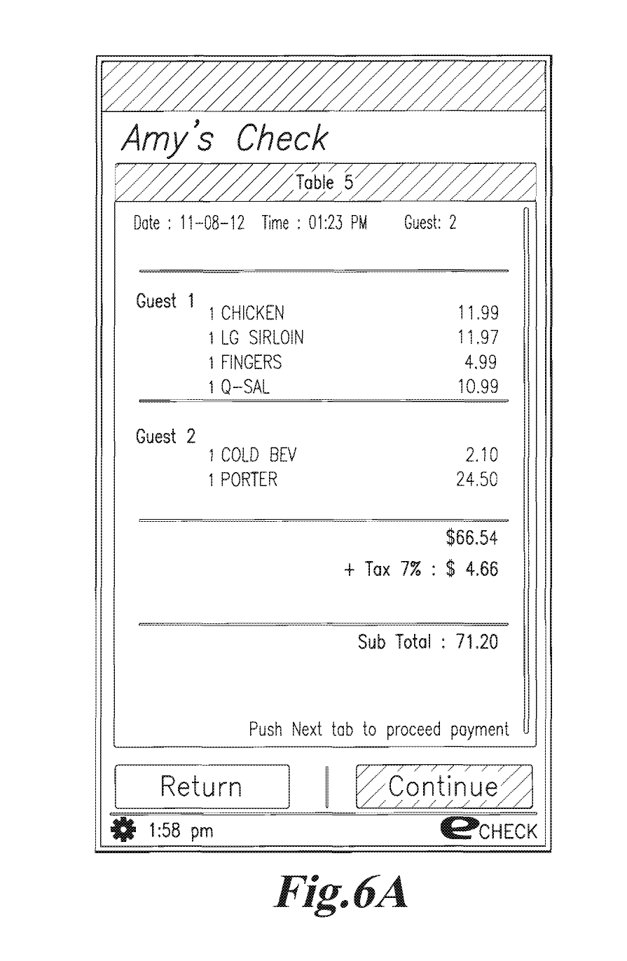

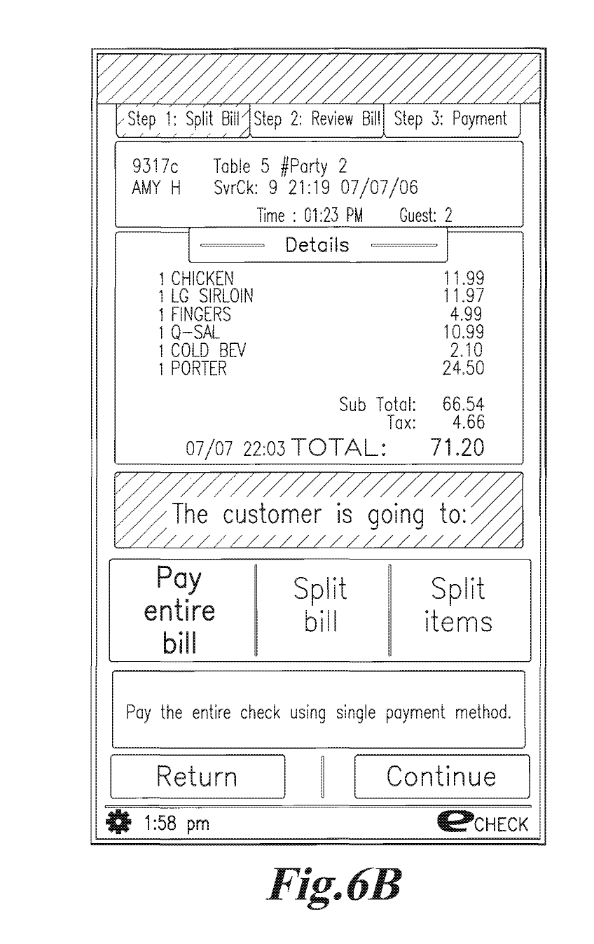

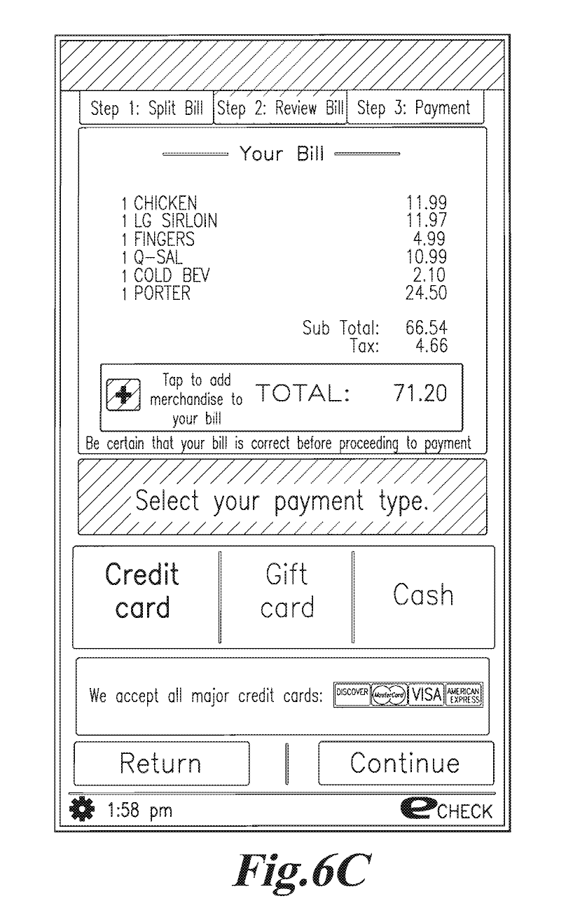

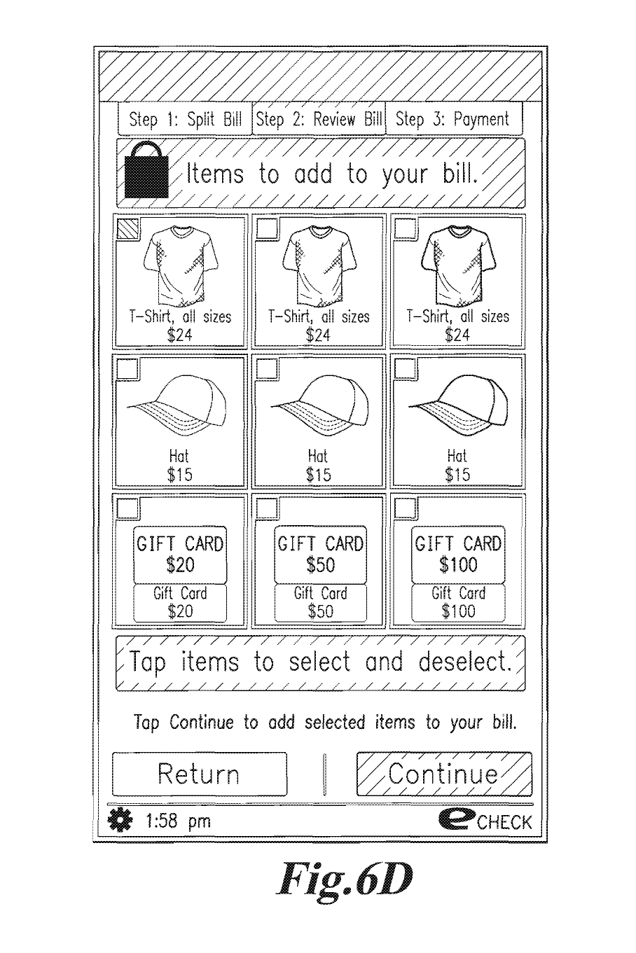

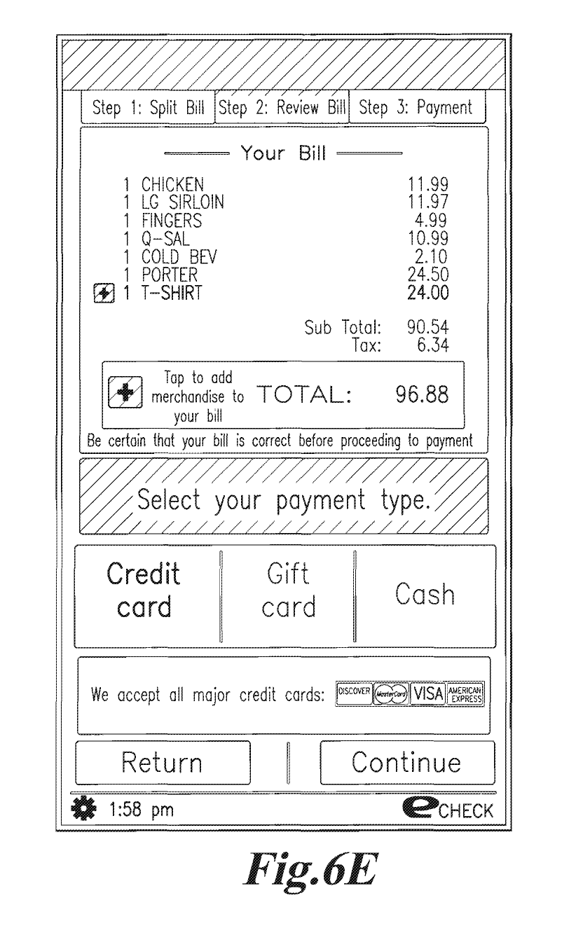

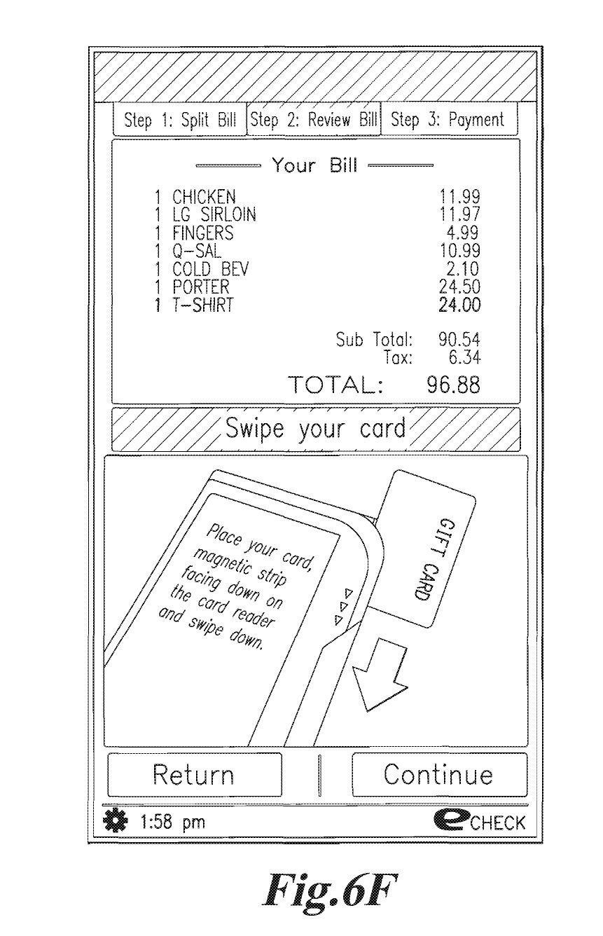

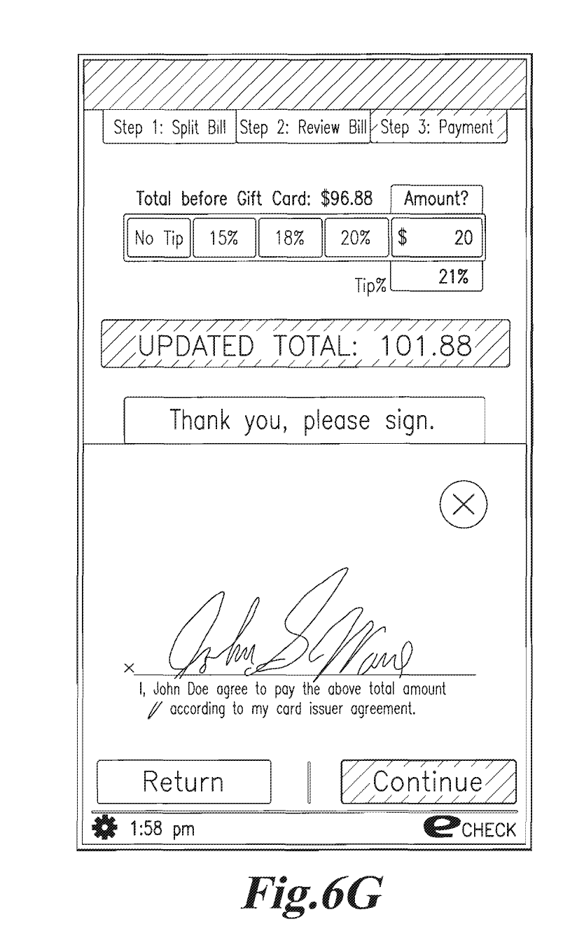

Finally, in 209 displays pertaining to customer checkout at a particular table are displayed. This is explained later with reference to FIG. 6.

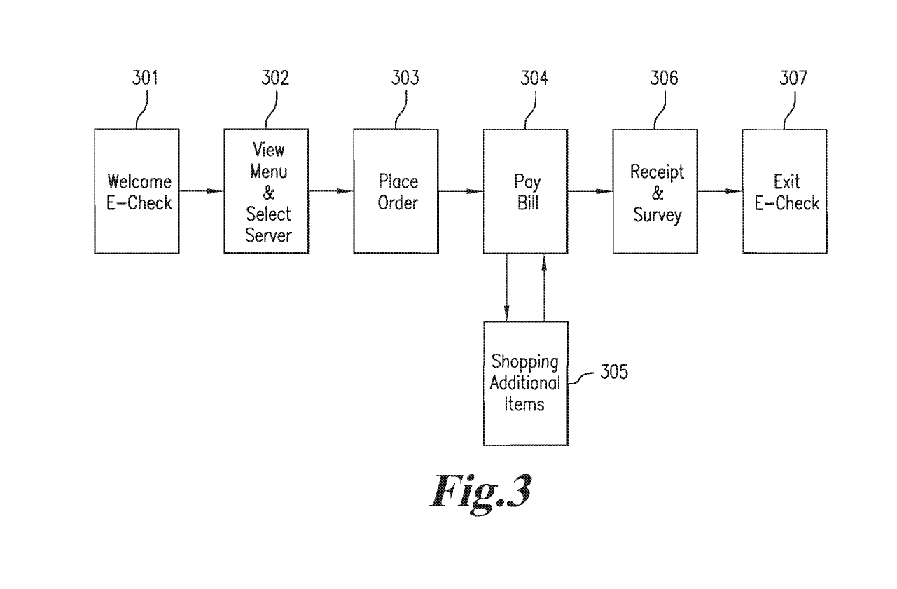

Similar to FIG. 2, FIG. 3 illustrates an exemplary block diagram depicting a sequence of displays on the E-check device when operated in the second mode.

In 301, a welcome message is displayed on the display of the E-check device. Upon the customer connecting to the restaurant's processing server, a menu page is displayed in 302. The menu, for example, may be displayed in a categorized format as appetizers, soups, salads, entrees, etc. and may also display the cost of each item under each category. Further, the entire menu can be viewed on the display with the use of a touch operation using the user's finger or a stylus and performing a scroll up/down operation.

In 303, the customer can place an order by appropriately selecting the desired food items from the menu by using the touch operation via the stylus or a finger. In 304 and 305, the customer can pay the bill corresponding to the order placed in 303 and can also engage in shopping activity which may be offered by the restaurant. Specific details pertaining to 304 and 305 are described later with reference to FIG. 6A-6G.

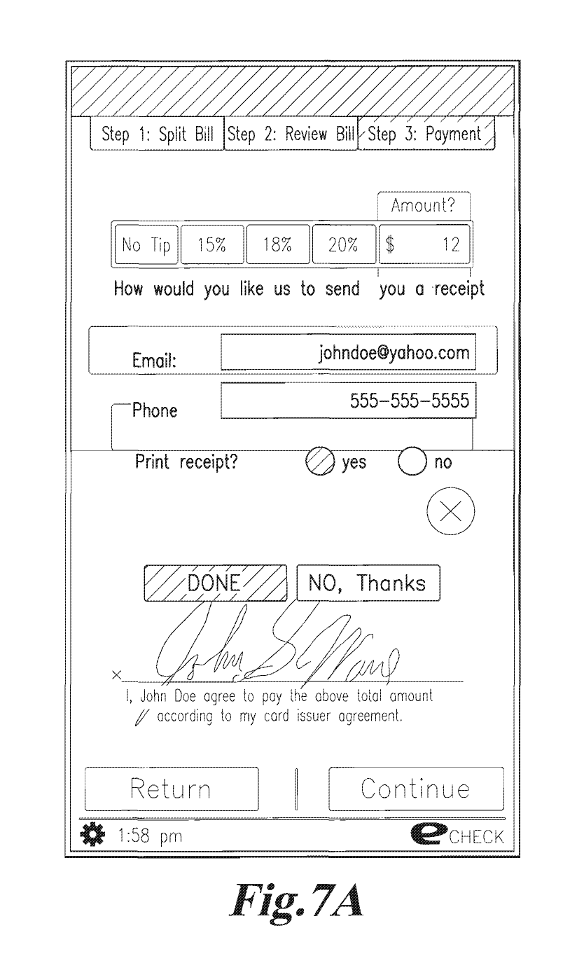

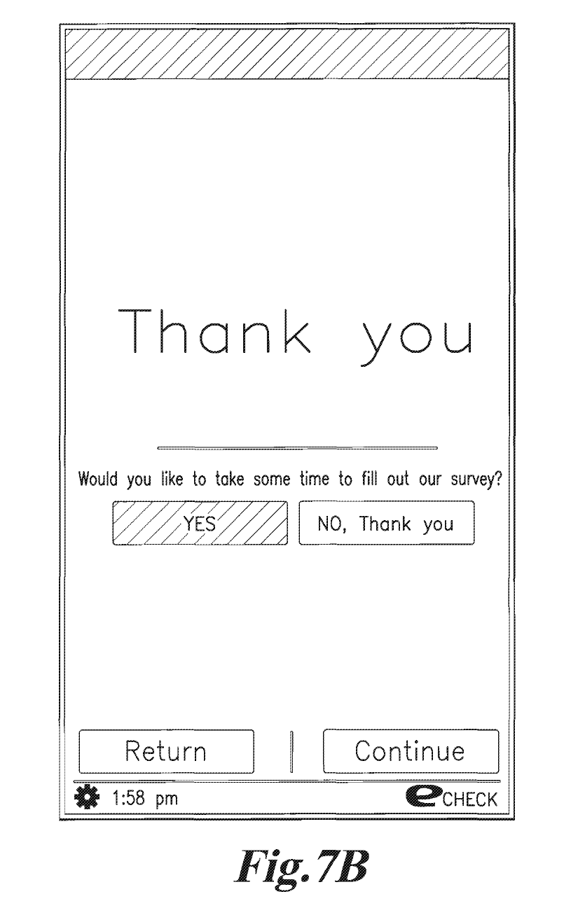

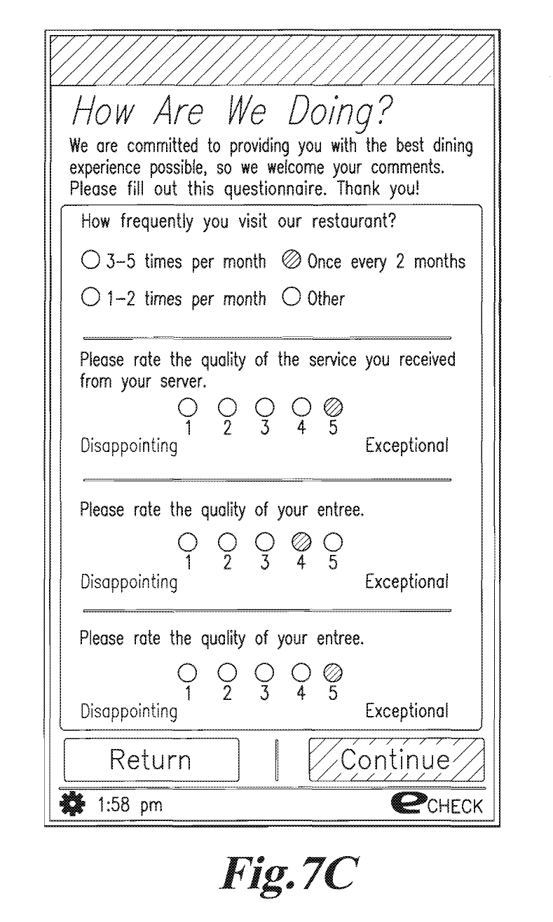

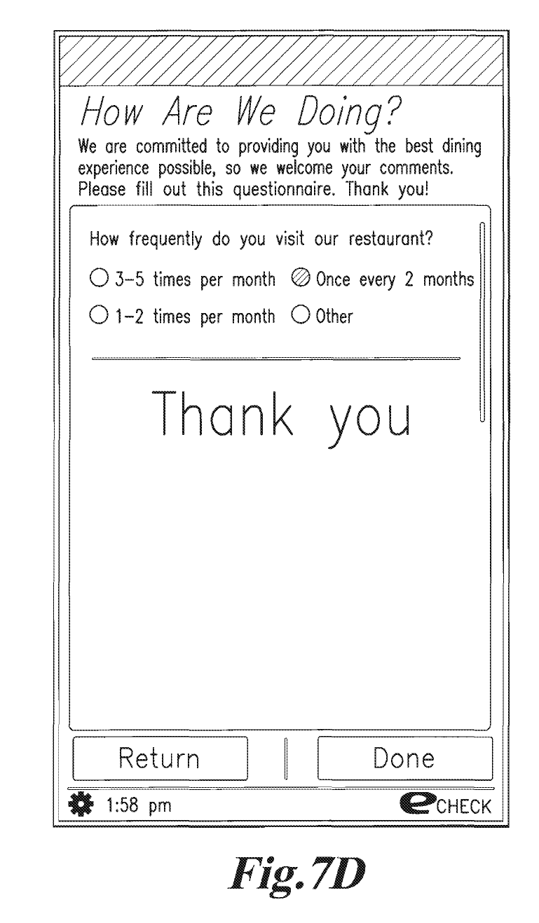

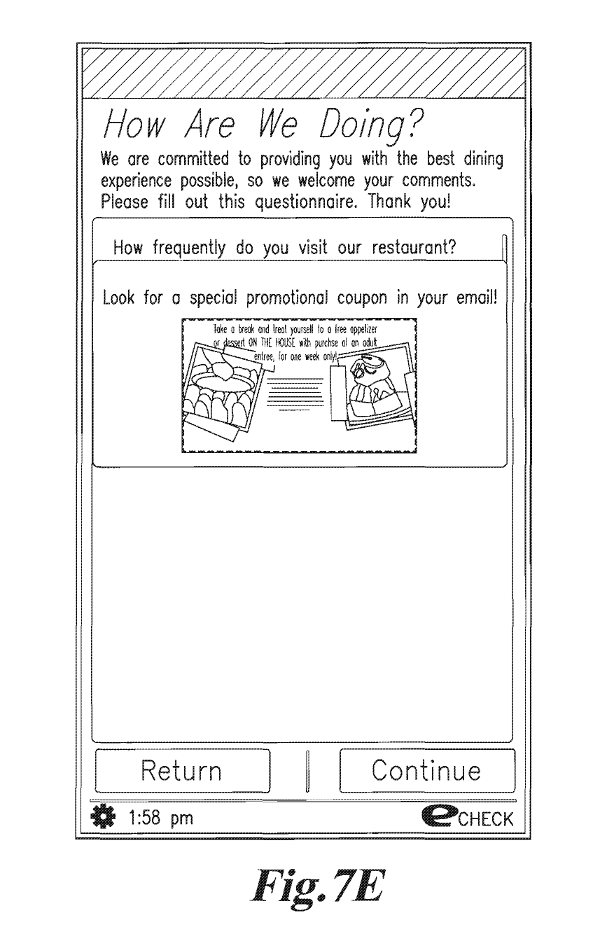

In 306, a customer survey form can be displayed on the E-check device. This is explained later with reference to FIG. 7. Finally upon completing the survey the customer can exit the E-check system where upon a message such as ‘Thank-You’ or the like may be displayed.

FIG. 4 illustrates an example depicting the information displayed on the E-check device while performing an attendant creation using the E-check device in the first mode.

The display in 401, displays three attendants currently stored in the E-check device. Specifically, the names of the attendants Jason, Amy, and Mark are displayed 420A-420C. Further, icons 421 (−) and 423 (+), which provide an option to either add or delete an attendant are also displayed. A return icon 431, and a continue icon 432 are also displayed at the bottom of the screen that enable a user to navigate from the current display to the previous display or the next display. To create an attendant, icon 423 can be touched or selected in order to illuminate the icon, where-after the continue icon can be selected in order to move to the next display. Alternatively, the E-check device can be configured to proceed upon simply touching the 423 icon.

In the next display 402, create a new attendant message is displayed at the top of the display screen and a box 425 is displayed immediately below the message. Box 425 represents an area where the name of a new attendant is entered by using the keypad 424.

Upon entering the name of the attendant, for example Jack Damon, a create passcode message is displayed in the box 425 as shown in 403. Further, an additional box 427 that includes four boxes is displayed along with a numeric keypad 424. This display indicates that he new an attendant should create a passcode for his account.

In 404, a confirm passcode message is displayed along with the numeric keypad and box 427.

Upon entering the passcode for a second time at 404, the screen displays the processing icon, indicating that a processing circuit embedded in the device is performing a matching operating to determine if the passcode entered at 402 and at 403 match.

Furthermore, according to another embodiment, if an attendant has already created his/her login passcode, the E-check device can be configured to simply allow the attendant to select the attendant's name from the list of attendants displayed on the E-check device, where upon the attendant may login to his/her account by simply inputting the already created passcode.

Note that the above description of displays is intended for the sake of illustration purposes only. Numerous variations are possible to the above described display information. For example, the passcode used above shows only the possibility of entering a numeric passcode. However, alpha-numeric passcode could also be used. Further, the passcode could be implemented by using a speech recognition technique, finger-print matching etc. to identify the user.

FIG. 5 depicts a detailed view of the table page of a particular attendant. The table page of a particular attendant corresponds to the tables currently assigned to that attendant.

In FIG. 5, for the sake of explanation, we depict the tables assigned to Amy. The tables assigned to Amy will be displayed only upon successful server login using the E-check device.

The display in 510 shows a total of nine tables arranged in a matrix form and displayed on the E-check device. Further, for each table, the number of guests occupying the particular table is also displayed. The return and continue icons are displayed at the bottom of the screen and provide a user friendly way to navigate from one display screen to the next. Also displayed is the current time 505, at the bottom of the display.

According to one embodiment, to enable an attendant to serve the meals to the customers in a timely manner, each table box can include an area 503 surrounding the box such that when the meal for a particular table is ready to be served, area 503 is configured to continuously blink thereby providing a visual display to the attendant that food for the particular table is ready. A restaurant processing server (explained later with reference to FIG. 8) can be configured to achieve the above described functionality.

Additionally, 520 depicts a similar configuration of the tables to the configuration shown in 510. In this configuration 520, the attendant can be notified of a meal completion by a customer. Specifically, as shown in 520, when the guests at table 5 have completed their meal, the corresponding table on the display can be highlighted as shown by the shaded area 504. This indication of meal completion can be initiated by the guests at the table using a similar E-check device that communicates with either the restaurant's processing server or another E-check device that is operated by the attendant.

FIGS. 6A-6G illustrates the displays pertaining to the checkout process of a customer. The checkout process of a customer corresponds to a payment of meals ordered by the customer, wherein FIG. 6A is a part of the first mode of operation of the E-check device. FIG. 6B may be a part of either the first and second mode. FIGS. 6C-6G is a part of the second mode of operation of the E-check device. However, these modes can be used interchangeably as necessary.

For the sake of illustration, a checkout process of Table 5 which has 2 guests is shown. In FIG. 6A, the display indicates, in a tabulated form, the meals ordered by the particular guests and also displays the cost of the corresponding items ordered. Further, the E-check device is configured to compute and display the sub-total of the meal and the corresponding tax to be charged to the customer for the meal. An indicator such as ‘push continue to proceed payment’ is also displayed on the screen along with the return and continue icons.

According to one embodiment, the E-check device may be configured to display only the total cost of the meal ordered. Further, an icon may be displayed on the E-check device which provides the customer an option to view a detailed view of the bill, upon tapping the icon. The detailed view of the bill can include the number of food items ordered, the cost of each food item, the name of the attendant serving the table, the time the bill was created and the like.

Further, the detailed view may also be configured to display the food items ordered per guest. This allows the guests to easily verify and make payments for the food items order by them respectively.

FIG. 6B depicts the display providing options to the customer to pay the bill. Specifically, in the upper portion of the display of the E-check device, a detailed list of the food items ordered by the guests along with the cost (individual food items, as well as the total amount) is displayed. Further, three options, ‘Pay entire bill’, ‘Split bill’ and ‘Split items’ are displayed on the screen, where-upon the customer can select one of the payment options by using the touch operation.

The pay-entire-bill option allows a single guest to pay the total cost of the meal. The split-bill option allows the guests to divide the total cost of the bill evenly between the guests, whereas the split items feature provides for splitting the items between the guests.

Upon selecting a manner in which the customer(s) intend to pay the bill and upon further pressing the continue icon displayed at the bottom of the display screen, an option of selecting a payment type is displayed. As shown in FIG. 6C, options such as credit card, gift cards, and cash are offered to the customer in order to complete the payment. The next display screen as shown in FIG. 6D, displays shopping items such as T-shirts, caps, gift-cards that the customer can purchase and pay for, in addition to the total cost of the meal ordered. The customer can select a particular shopping item by using a touch operation, thereby selecting the particular item. For example, as shown in FIG. 6D, each shopping item is displayed in a box, wherein each box further includes a small box located in the upper right hand corner, which is highlighted upon the customer selecting the particular item. The cost of the corresponding item selected is added to the meal total as shown in FIG. 6E.

According to another embodiment, in addition to the shopping items being displayed, a list of deserts, coffee, tea, or any other food items commonly consumed by the customer after the meal can also be displayed. A restaurant processing server (explained later with reference to FIG. 8) can be configured to keep track of the food items consumed by the customer. Accordingly, in this manner, the restaurant can provide a sense of personalized service to the customer and maintain customer loyalty. Further, according to yet another embodiment, the complete restaurant menu may be displayed on the E-check device. This provides the customer an option to place a food order for take-out.

Upon selecting the shopping item, the customer can proceed to checkout by tapping the continue icon. The next display as shown in FIG. 6F, displays an itemized list of the meal ordered along with any shopping items that the customer has purchased. A final total due is also displayed. In the bottom portion of the display panel, a picture of the E-check device is displayed that depicts a card swipe or tap operation, thereby instructing the customer to swipe or tap his credit/gift card on the E-check device to complete the payment.

In FIG. 6G, upon successful processing of the payment information (explained later with reference to FIG. 8), an option for selecting a tip amount is also displayed. Tip options such as no tip, 15%, 18%, 20% and a customer specific amount are displayed. Upon the customer selecting a particular tip amount, the final total of the bill including the tip is also displayed. Further, in the lower portion of the display a signature box is displayed, wherein the customer is instructed to authenticate the transaction by providing his signature. The customer could either use the stylus included with the E-check device or use his finger to enter his/her signature in the E-check device.

It must be appreciated that by the E-check payment method as explained above, the customer can pay for the meal/shopping using a credit/gift card immediately, without having to wait for the attendant to bring a copy of his bill. This approach completely eliminates the wait time for the customer thereby providing a pleasant experience in dining and shopping. Further, from a security perspective, the customer is concern-free of potential identity theft, as the credit card is always in the possession of the customer.

According to another embodiment, the E-check device 100 when operated in the second mode (by the customer), may communicate with the attendant (first mode) thereby requesting his presence at the table to process the payment information for the customer. Specifically, the attendant can input the payment details in the E-check device 100, such as split bill, spilt bill by guests, which card(s) do the customers intend on using or the like, and have the customer simply swipe their cards to complete the payment. Doing so saves the customer the hassle of inputting information regarding the payment.

Furthermore, the customers may optionally choose to hand over their credit cards to the attendant and let the attendant handle all of the transaction processing for the meal. Alternatively, according to another embodiment, the customer can perform all the payment processing of the bill by himself. This option may be chosen if the particular attendant is busy and thus provides the customer an option to reduce the wait time.

FIGS. 7A-7E illustrate information displayed on the E-check device corresponding to printing a receipt of a bill and conducting a survey by the customer.

In FIG. 7A, an option to enter an email address, telephone number, as well a query asking the customer if he intends to print a hard copy of the bill is displayed. Further, two icons labeled ‘Done’ and ‘No Thanks’ are also displayed. If the customer selects the latter option the printing of the receipt is bypassed. However, the customer may have a copy of the receipt directly sent to his email address. This option further avoids any delays incurred by the customer to wait for the attendant to get a copy of his receipt.

Alternatively, upon entering the required information as shown in FIG. 7A, and selecting ‘Done’, succeeded by pressing the continue icon the display shown in FIG. 7B is displayed on the E-check device. The printing of the receipt is explained later with reference to FIG. 8.

In FIG. 7B, the customer is queried if he/she would like to participate in a survey. Similar to FIG. 7A, icons such as ‘Yes’ and ‘No Thank you’ are displayed, one of which can be selected by the customer using a touch operation. If the customer selects ‘No Thank you’, the customer can exit the E-check system.

Alternatively, if the customer selects ‘Yes’ in response to the query, the displays of FIG. 7C and FIG. 7D are sequentially displayed on the E-check device. As shown in these figures, the customer is asked a series of questions and instructed to select an answer from a plurality of options for each question. Upon completing the survey, a thank you message such as ‘Thank you’ can be displayed along with a message indicating the customer to look out for special promotional coupons in his email (as shown in FIG. 7E) can be displayed. Further, the information displayed on the E-check device is not limited to presenting coupons of that particular restaurant only. The processing server can be configured to display specific advertisements, shopping products that may be purchased at a discounted rate, special promotions or the like based on the customers previous purchases or based on information collected from the survey. By performing such recommendations, a unique experience may be provided to the customer. The customer upon successful completion of the survey can exit the E-check system.

Advertising can be presented at any point during the payment process. For example, advertising can be presented before the survey, while the credit card is being processed, or sometime after. The user could simply select a button on the advertisement or the advertisement itself to have more information forwarded to an email account on file. The advertisement could be for local establishments or for large corporations and can be selected for display based on user profile information.

FIG. 8 depicts a diagrammatic representation of an E-check restaurant system 800 according to one embodiment. The system 800 includes a plurality of E-check devices 100, labeled 801, 802, 803, 804, and 805. The system 800 further includes a restaurant processing server 820, processing terminals 815A and 815B that are connected to the restaurant's processing server 820, a kitchen processing server 830, a local area network (LAN) 840, a communication network 850, and a credit card processing server 860. The processing terminals 815A and 815B can include an interface 816A and 816B that enable the E-check devices to communicate with the restaurant processing server 820.

The E-check devices 100 may be connect to the restaurant processing server 820 via a WiFi connection or the like. For example, certain E-check devices 801, 802 and 803 may connect to the restaurant processing server 820 via WiFi, 810. On the other hand E-check devices 804 and 805 may connect to the restaurant processing server via a Bluetooth wireless connection 812. For example, a Bluetooth personal area network (PAN) may be used wherein Bluetooth enabled E-check devices that are part of the PAN, may gain access to the restaurant processing server 820.

Further, the restaurant processing server 820 may connect to the kitchen processing server 830 and E-check devices 100 using the Bluetooth PAN. This may be easier than connecting the restaurant processing server to multiple devices individually. Note that connecting to a PAN can automatically create a TCP/IP connection between the server 820 and other Bluetooth enabled devices. Alternatively, the restaurant processing, server 820 may connect to the kitchen processing, server via the LAN 840 or may be connected by a dedicated communication channel. The connection between the processing terminals (815A, 815B) and the restaurant processing server 820 need not necessarily be a hard-wired connection. The processing terminals may located at different locations within the restaurant premise and connect to the restaurant processing server in a wireless manner using any of the above described methods.

The E-check devices 801-805 are not restricted to communicate with the restaurant processing server using the above described methods. Specifically, the E-check devices may communicate with the server 820 using near field communication (NFC). For example, NFC standards that cover communications protocols and data exchange formats, which are based on radio-frequency identification (MID) standards including ISO/IEC 14443 and FeliCa may be used.

The E-check devices 801-805 may communicate with the kitchen processing server 830 to place and track the respective orders and get information pertaining to the respective wait times for their orders to be delivered based upon the customer traffic in the restaurant. Communication between the E-check devices and the kitchen processing server 830 may use any of the wireless communication methods described above. Accordingly, upon receiving a plurality of orders from the customers, the kitchen processing server 830 may use this information to update inventory records of various raw materials and accordingly notify the restaurant processing server 820. The inventory tracking can also be used to maintain a record of trends in customer purchases or special orders to improve the products or services. For example, the E-check system can be used to monitor tendencies for particular dishes/food products in selected regions. The E-check system can track orders by locale OF specific regions to determine dishes popular in a particular region. Such information that is maintained by the E-check system can also help determine what food preferences are popular in certain areas.

Further, the customer using the E-check device 100 may make a payment of his order using the method as described previously and directly transmit the payment information to the restaurant processing server 820 wirelessly. Optionally, the customer may also make a payment by using the processing terminals 815 by either using a wired connection or NFC type communication method to transmit the payment information to the restaurant processing server 820.

Upon receiving the payment information, the restaurant processing server can initiate a dedicated connection to the credit card processing server 860, to verify the payment information, Note that the credit card processing server may be a centrally located repository or a distributed information database, which upon receiving a query from the restaurant processing server 820, may perform information processing to notify the restaurant processing server whether the payment information has been accepted or denied,

The processing terminals 815A and 815B of the E-check system can be connected to printer wherein the customer upon successful payment of the order may choose to print a copy the receipt (bill) of the order. Optionally, the customer can use the E-check device 100 to have the system email a copy of the receipt to an email account. Further, the processing terminals, in addition to transferring payment information to the restaurant processing server 820, may obtain additional information of the user through use of email based receipts. Specifically, the B-check system can obtain dining habits of the customer, maintain a rewards account or an business account and keep track of the purchases of the user. Furthermore, the customer could enter additional information into the restaurant processing server 820 by completing a survey that is offered by the restaurant. Information regarding the particular customer can be stored in a central repository or memories included in the restaurant processing server 820. This information could be used to improve customer experience by making recommendations based on the customer's previous orders.

The E-check system can also include a mobile or computer application which enables monitoring of all transactions in real-time. The system can be configured to allow a proprietor or manager to track all transactions or select a particular transaction which is currently being processed. The mobile application to track all transactions can be implemented by the proprietor using a remote internet connection or a network based program or page that enables monitoring of transactions in real-time. Furthermore, the restaurant processing server can be realized by using a virtual terminal (located in the restaurant) that communicates with a remote server using a cloud computing technique. This lowers the maintenance cost incurred by the owner (proprietor) of the business,

While certain embodiments of the E-check system have been described, these embodiments have been presented by way of example only, and are not intended to limit the scope of the inventions. Indeed the system embodiments described herein may be embodied in a variety of other forms; furthermore, various omissions, substitutions, and changes in the form of the systems described herein may be made without departing from the spirit of the inventions. For example, an embodiment of the E-check system may include the restaurant processing server and the kitchen processing server as one central server communicating with all E-check devices in the restaurant. Further, there may be a plurality of sub restaurant servers located at various locations within the restaurant. In this case, the sub-servers may communicate to one central server to store and process information.

Furthermore, an E-check device operated by a customer may communicate with the E-check device of the attendant in order to signal the attendant that the customers require some assistance. This feature can be enabled, for example, by having an icon on the display of the E-check device, which when pressed by the customer, sends a signal either to the restaurant processing server (or directly to the attendant) by using, the WiFi, PAN network described earlier.

Additionally, the functionality the E-check device can be realized by using a mobile or handheld device such as a smart phone, tablet, or the like and downloading or installing application software thereon to perform the features described above. Additionally, a card reader, EMV reader, NFC reader can be interfaced with the device via the headphone jack (terminal) or a USB port, which is commonly found in such devices. Thus the process of placing a food order, shopping, and performing payment transactions can be achieved using a tablet/mobile type device.

Alternatively, the above described functionalities of the E-check device can be achieved by a combination of devices. Specifically, an E-menu device that includes a display (touch panel) may be used to place the order, communicate with a restaurant processing server and the like. The processing server may be configured to display users' meal preferences, user account details such as last visit etc., on the E-menu device along with the E-menu of the restaurant. The E-menu device can be placed, for instance, at each table in the restaurant, thereby providing an easy means for the customer to place the order. Further, E-menu device may also be configured to communicate with the attendant (operating an E-payment device) using any of the communication means described earlier. The E-payment device may include an electronic card reader, EMV reader, NFC reader or the like and can be used to process the customer's payment information.

According to another embodiment, the E-check or the E-menu device can communicate with an E-pager device that is held by the attendant. For example, the E-pager device can be disposed on the attendant's wrist or be attached at any suitable location such as on the waist of the attendant or the like and is configured to vibrate when it receives a signal from the E-menu or E-check device. Therefore the E-pager device can provide a tactile indication to the attendant that a customer requires his service. The E-check or E-menu device can be configured to send a signal to the E-pager by having an icon displayed on the touch panel, whereby upon performing the touch operation a wireless signal can be sent to a specific E-pager. In doing so, the customer avoids having to wait for the attendant to check if his services are required, and provides the customer a time-saving option of calling the attendant as and when he desires in a seamless manner. Furthermore, the E-pager device could also be a mobile phone or the like, wherein an installable or downloadable application for the phone may be used to realize the communication between the customer and the attendant.

As stated above, the E-check device or the E-menu device can be operated by a customer to view the restaurant's menu and place his meal order. The restaurant processing server can recommend food items based on the customer's previous orders or based on a customer's profile that may be stored in the restaurant processing server. Alternatively, according to another embodiment, the customer's profile can be integrated with a social media such as Facebook™ or the like, wherein the customer can integrate his restaurant dining account his social media account and can view reviews of a particular food item of the restaurant consumed by other people, and view the number of people who recommend a particular food item on the restaurant's menu and the like. This provides the customer with a truly interactive dining experience when placing his food order.

Furthermore, the restaurant server can be configured to provide to the customer a display on the E-check or E-menu device, which shows the nutritional facts about a particular food item that the customer intends to order. Furthermore, a video-icon can be displayed next to each food item ordered by the customer, wherein upon performing a touch operation or the like, a brief video of how the food is prepared, what ingredients are used or the like can be viewed by the customer. The restaurant server may also be configured to transmit food recipes (of the customers liking), newsletters or the like to the E-check or E-menu device. For example, the recipe can be requested by selecting an icon on the menu. For instance, the recipe request on can be positioned proximate to the video-icon.

The E-check system can also be configured to take as input a customer's particular dietary requirements/preferences and recommend food items to the customer based on his/her diet. For example, the customer may input a particular cholesterol level, protein intake, fat content, allergies or the like that he desires in his meal. The restaurant server can be configured to recommend food items based on such dietary requirements/preferences of the customer. Furthermore, the restaurant system may be enabled to provide the customer an option to customize a particular food item from the restaurant menu if it is so desired. Specifically, the customer has an option to configure the ingredients of a particular meal item by viewing the items currently used to prepare the food item and configuring a particular ingredient(s) to prepare the food item according to his preference.

Further, according to another embodiment, the E-check device and/or the E-menu device can be used to provide a customer a virtual dining experience. Specifically, restaurants usually encounter busy periods during the day/night wherein the restaurant is either operating at full table capacity or the number of attendants in the restaurant are less in order to provide a quick and timely service to the customers.

In such scenarios, the restaurant system can be configured to provide the customer option of being served their meal without having a dedicated attendant. Specifically, the customer may use the E-check device (E-menu device) to place their order and have at least one server bring them their order without any further service. Alternatively, the restaurant system can be configured to update a virtual service to a real service, wherein the customer initially places the meal order using the virtual service. Based on the customer traffic in the restaurant or the number of free attendants available after a predetermined amount of time, the restaurant processing server may be configured to update the status of the customer from a virtual diner to a real diner, wherein an attendant may be assigned to the customer.

According to another embodiment, the E-check system can be configured to operate with an E-check rewards card. The E-check rewards card can be used for special customers such as business individuals, celebrities, VIP's, CEO's, or the like. Further, the E-check rewards card can for example include different levels of rewards such as silver, gold, platinum or the like to provide enhanced services for its frequent and royal customers. In order to provide excellent service to such customers, the E-check rewards card can be configured to notify, for example, a particular attendant frequently used by the customer upon his/her arrival. The E-check rewards card can be configured to communicate with the restaurant's processing server for example, in order to notify the attendant, a maître d′ or a valet attendant. Further, the E-check rewards card can be used to reserve a particular table of choice of the customer, provide the customer with a cocktail or beverage of his desire upon his arrival and perform other services in order to provide an excellent dining experience for the customer.

The communication between the E-check rewards card and the restaurant processing server can accomplished by using RFID, NFC communication or the like with the system server.

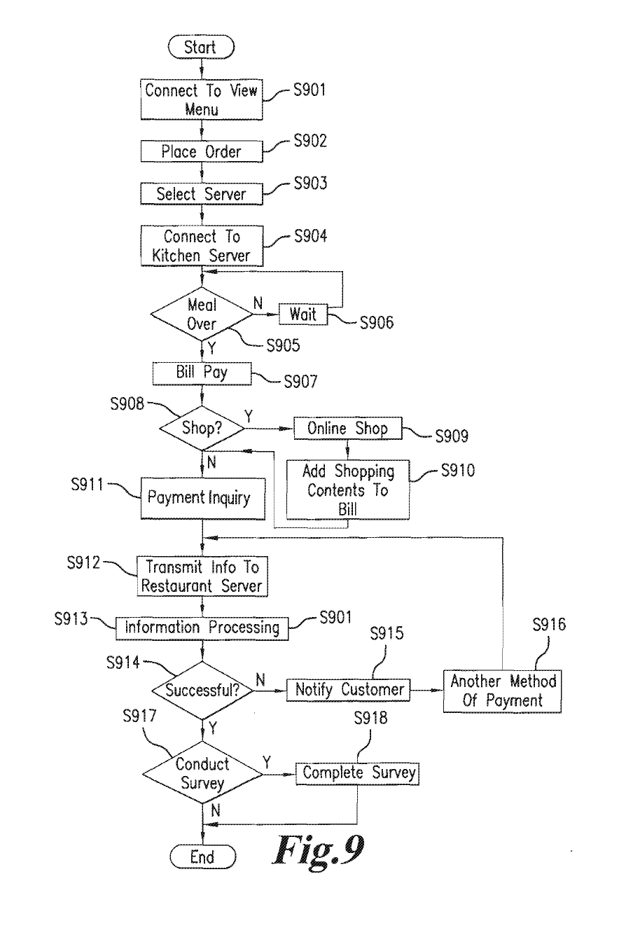

FIG. 9 is a flowchart illustrating an exemplary process of using the E-check and/or the E-menu device in the restaurant system of FIG. 8.

In step S901, a customer can connect the E-check and/or E-menu device (via a wireless communication method as explained with reference to FIG. 8) to a restaurant processing server. In doing so, the restaurant menu can be viewed (for example as an HTML web page) on the display panel of the E-check and/or E-menu device.

In step S902, the customer can place an order on the E-check and/or E-menu device utilizing one of a touch panel, a voice input, and a stylus.

In step S903, the customer can select a particular attendant of his choice (if a frequent visitor), by using the attendant created list (FIG. 2) displayed on the E-check and/or E-menu device.

In step S904, the E-check and/or E-menu device is connected to a kitchen processing server in order to enable the customer track his meal order and obtain information pertaining to the meal's delivery time.

In step S905, a query is made to check whether the customer has finished consuming his meal. If the response to the query is affirmative, the process proceeds to step S907. If the response to the query is negative, the process proceeds to step S906.

Step S906 is a wait state, which signifies that the customer has not finished his meal. The process therefore simply loops back to step S905, wherein the query is made (after a wait period) to check if the customer has finished his meal.

In the event that the customer has finished his meal, in step S907, the customer can immediately proceed to view his bill on the E-check and/or E-menu device without waiting for his attendant to process the check. This is possible as the customer in step S902 placed the order using the E-check and/or E-menu device which was stored in a local repository of the restaurant (e.g., the restaurant server).

In step S908, a query is made to check if the customer wishes to engage in a shopping activity, If the response to the query is affirmative, the process proceeds to step S909. If the response to the query is negative the process moves to step S911.

In step S909, the customer is presented with shopping items as explained with reference to FIG. 6F. The process then proceeds to step S910, wherein the customer can add shopping items to the restaurant bill.

In step S911, the customer can view a payment inquiry on the E-check and/or E-menu device. For example, the customer can view a plurality of options to make a payment transaction. Specifically, the customer(s) can decide if the bill amount is to be paid in full, or split by guests etc. as explained in FIG. 6B-6F.

Upon selecting the payment method, the process moves to step S912, wherein information pertaining to the payment is transmitted to the restaurant server. In step S913, the restaurant processing server processes the received information to verify the validity of the information. For example, if the payment was made by a credit card, the restaurant processing server transmits the received information to a credit card processing server as explained in FIG. 8.

In step S914, a query is made to check if the payment was successful. If the response to the query is negative, the process moves to step S915. Otherwise the process moves to step 917.

If the credit card processing server sends a notification to the restaurant processing server that the information is invalid, the restaurant processing server, in step S915, notifies the customer accordingly of this event, by displaying an appropriate message on the display panel of the E-check device.

The process then moves to step S916 wherein the customer selects an alternate form of payment such as another credit card etc., and the process loops back to step S912.

If the response to the query in step S914 is affirmative, the process moves to step S917 wherein the customer is presented with an option to take part in a survey as explained in FIG. 7. If the response to the query is affirmative in step S915, the process moves to step S918 whereupon the customer completes the survey on his E-check device. Upon completion the process ends. If the response to the query in S917 is negative, the process simply ends without completion of the survey.

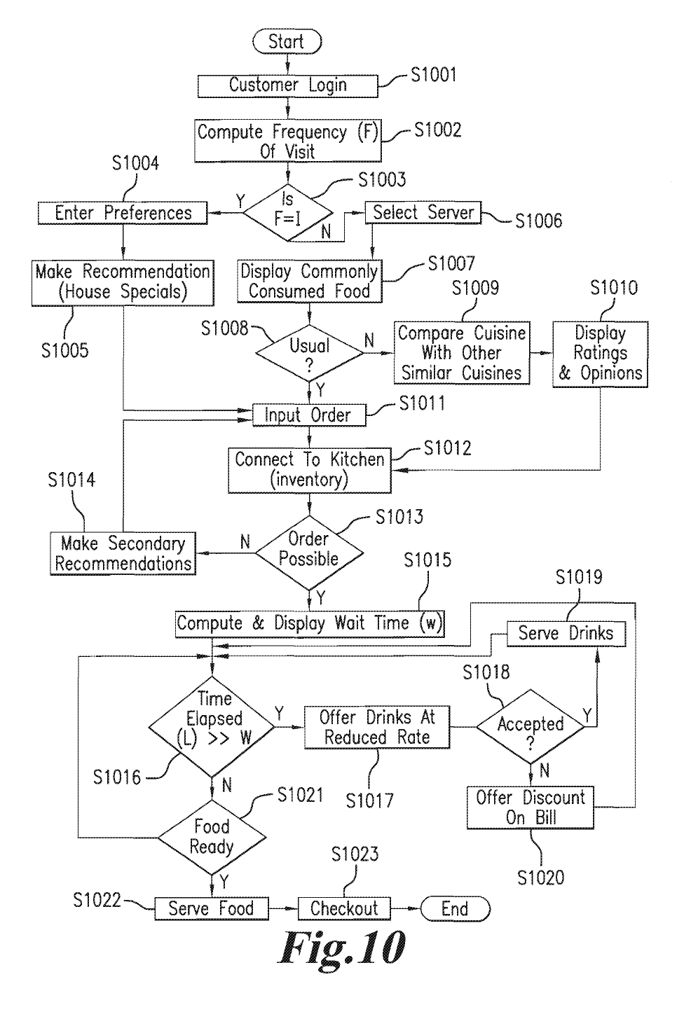

FIG. 10 is an exemplary flowchart depicting a customization of a user's dining experience in a restaurant using the E-check and/or E-menu device.

In step S1001, the user (customer) performs a login operation using the E-check and/or E-menu device. Specifically, the customer can connect to the Internet via a WiFi connection or the like and login to a rewards account of the restaurant (if a frequent visitor) or simply connect to the restaurant's menu if the user s a first time visitor. Further, the customer may swipe the E-check rewards card or use RFID, NFC or the like to perform a login operation. Additionally, for a first time visitor an option may be provided to create a rewards account with the restaurant. Even if the user does not log into the establishment system, it would be possible to track the user via credit card payment subject to any privacy laws or credit card agreements. It would also be possible to query the user regarding whether they wish for their information to be stored in the restaurant system after payment is complete.

In step S1002, a frequency of visit (F) for the customer is computed based on previous visits. Specifically, the customer can configure the E-check and/or E-menu device to keep a track of the previous visits over a predetermined length of time (such as number o times visited over the past month, week, etc.).

In step S1003, a query is made to check if the frequency of visit (F) is equal to one. If the response to the query is negative the process proceeds to step S1006, otherwise the process moves to step S1004.

In step S1004, since the customer is a first time visitor, the customer's food preferences are input. Then in step S1005, based on the customer's preferences, the E-check system can make recommendations from the restaurant's menu to the customer. For example, if there is a match between the customer's preferences and the restaurant's special menu, the E-check system can make recommendations to the customer. The process then proceeds to step S1011.

If the response to the query in step S1003 is affirmative (indicating that the customer is a frequent visitor), the process may optionally proceed either to step S1006 (and thereafter step 1007), wherein the customer can select a particular attendant of his/her choice. However, the process may also proceed directly to step S1007. In step S1007, based on the customer's previous food choices, the most commonly consumed meal at that restaurant or a recommended meal can be displayed on the display panel of the E-check and/or E-menu device. Alternatively, the meal choice during the last visit of the customer can also be displayed to enable the customer to place an order for the current visit.

In step S1008, a query is made to check if the customer wants to order a meal that includes his favorite food items. If the response to the query is affirmative, the process moves to step S1011. If the response to the query is negative, the process proceeds to step S1009.

In step S1009, the customer can compare the restaurant's cuisines to other similar restaurants visited. The customer may compare prices of food items in the particular restaurant with other restaurants, check which food item in the restaurant is highly recommended by previous guests or the like. The process then proceeds to step S1010, wherein the customer can view ratings of restaurant currently visited and compare the rating with the ratings of other restaurants posted by other users. Alternatively, the customer can also view opinions of certain dishes posted by other users to enable him select his meal.

In step S1011, the customer places his meal order using the E-check and/or E-menu device after which the process proceeds to step S1012, wherein the customer can use the E-check and/or E-menu device to connect to a kitchen processing server as explained before with reference to FIG. 8.

The process then moves to step S1013 where a query is made to identify if the order, as placed by the customer, in step S1011 is feasible. Specifically, based on the input order, an inventory check can be performed to ensure that there are sufficient raw materials present to prepare the customer's order or whether the customer can make a customized meal based on different or customized ingredients of the meal. If the response to the query is negative, the process moves to step S1014, where secondary recommendations can be made to the customer, after which the process simply loops back to step S1011.

If the response to the query in step S1013 is affirmative, the process proceeds to step S1015 wherein the wait time (W) for delivering the customers meal can be displayed on the E-check and/or E-menu display panel. Note that the wait time can be based on how many other orders are pending in the kitchen and also on the time required to cook the customer's meal based on the cooking complexity of the meal.

The process then proceeds to step S1016 wherein a query is made to check if the time (L) elapsed from the time the customer places his order is greater than the estimated wait time (W) computed in step S1015. If the response to the query is negative the process proceeds to step S1021. If the response to the query is affirmative the process moves to step S1017.

In step S1017, the restaurant may, for example, offer beverages to the customer at a reduced rate due to the elongated delay in serving the food. The process then moves to step S1018.

In step S1018, a query is made to check if the customer has accepted the offer of ordering beverages at the reduced rate. If the response to this query is affirmative, the beverages can be served in step S1019 after which the process loops back to step S1015, wherein a new waiting time for the customer can be computed. If the response to the query in step S1018 is negative, the process proceeds to step S1020 wherein a discount can be offered to the customer as a token of appreciation for their patience. The process thereafter proceeds to step S1015.

If the response to the query in step S1016 is negative, the process proceeds to step S1021 wherein another query is made to check if the meal ordered by the customer is ready. If the response to this query is negative, the process simply loops back to step S1016. If the response to the query is affirmative, the process proceeds to step S1022.

In step S1022, the meal is served to the customer wherein-after the process moves to step S1023 where the customer is presented with the bill for his order and can proceed to checkout by making payments for this meal as described with reference to FIG. 8.

Upon checkout, the process of a customizing of a user's dining experience ends. Note that the exemplary embodiment of customizing a user's dining experience as presented in FIG. 10 has been presented by way of example only, and is not intended to limit the scope of the invention. Indeed the flowchart described herein may be embodied in a variety of other forms; furthermore, various omissions, substitutions, and changes to the method of FIG. 10 can be made without departing from the spirit of the inventions.

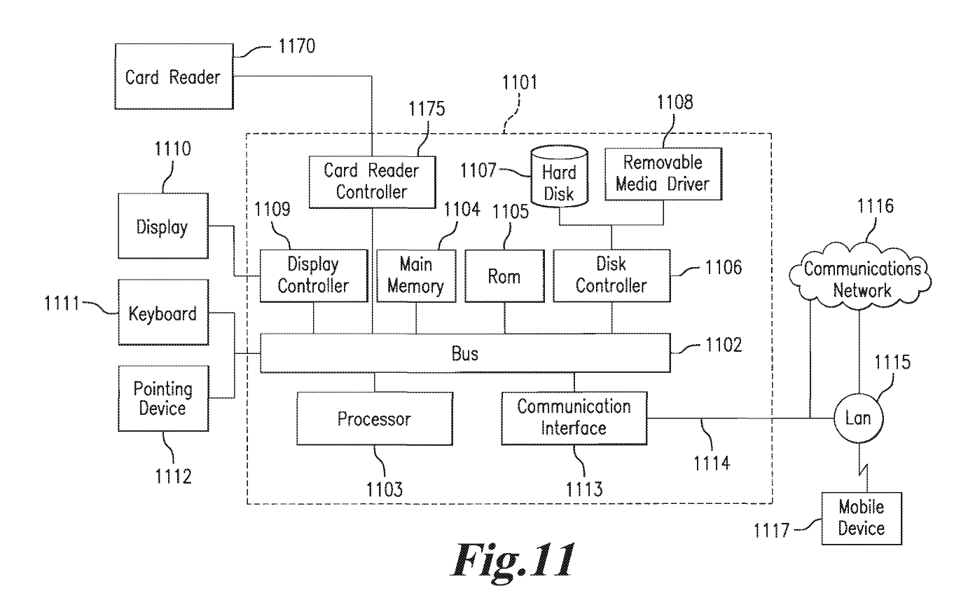

The E-check and E-menu device described herein can be controlled using a computer processing apparatus or programmable logic. FIG. 11 illustrates a computer system 1101 that functions as a controller configured to control the E-check and E-menu device.

The computer system (controller) 1101 includes a disk controller 1106 coupled to the bus 1102 to control one or more storage devices for storing information and instructions, such as a magnetic hard disk 1107, and a removable media drive 1108 (e.g., floppy disk drive, read-only compact disc drive, read/write compact disc drive, compact disc jukebox, tape drive, and removable magneto-optical drive). The storage devices may be added to the computer system 1101 using an appropriate device interface (e.g., small computer system interface (SCSI), integrated device electronics (IDE), enhanced-IDE (E-IDE), direct memory access (DMA), or ultra-DMA).

The computer system 1101 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1101 may also include a display controller 1109 coupled to the bus 1102 to control a display 1110, for displaying information to a computer user. The computer system includes input devices, such as a keyboard 1111 and a pointing device 1112, for interacting with a computer user and providing information to the processor 1103. The pointing device 1112, for example, may be a mouse, a trackball, a finger for a touch screen sensor, or a pointing stick for communicating direction information and command selections to the processor 1103 and for controlling cursor movement on the display 1110. Further, the system may include a card reader controller 1175 to control an electronic card reader 1170 of the E-check device.

The processor 1103 executes one or more sequences of one or more instructions contained in a memory, such as the main memory 1104. Such instructions may be read into the main memory 1104 from another computer readable medium, such as a hard disk 1107 or a removable media drive 1108. One or more processors in a multi-processing arrangement may also be employed to execute the sequences of instructions contained in main memory 1104. In alternative embodiments, hard-wired circuitry may be used in place of or in combination with software instructions. Thus, embodiments are not limited to any specific combination of hardware circuitry and software.

As stated above, the computer system 1101 includes at least one computer readable medium or memory for holding instructions programmed according to the teachings of the present disclosure and for containing data strictures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes.

Stored on any one or on a combination of computer readable media, the present disclosure includes software for controlling the computer system 1101, for driving a device or devices for implementing the invention, and for enabling the computer system 1101 to interact with a human user. Such software may include, but is not limited to, device drivers, operating systems, and applications software. Such computer readable media further includes the computer program product of the present disclosure for performing all or a portion (if processing is distributed) of the processing performed in implementing the invention.

The computer code devices of the present embodiments may be any interpretable or executable code mechanism, including but not limited to scripts, interpretable programs, dynamic link libraries (DLLs), Java classes, and complete executable programs. Moreover, parts of the processing of the present embodiments may be distributed for better performance, reliability, and/or cost.

The term “computer readable medium” as used herein refers to any non-transitory medium that participates in providing instructions to the processor 1103 for execution. A computer readable medium may take many forms, including but not limited to, non-volatile media or volatile media. Non-volatile media includes, for example, optical, magnetic disks, and magneto-optical disks, such as the hard disk 1107 or the removable media drive 1208. Volatile media includes dynamic memory, such as the main memory 1104. Transmission media, on the contrary, includes coaxial cables, copper wire and fiber optics, including the wires that make up the bus 1102. Transmission media also may also take the form of acoustic or light waves, such as those generated during radio wave and infrared data communications.

Various forms of computer readable media may be involved in carrying out one or more sequences of one or more instructions to processor 1103 for execution. For example, the instructions may initially be carried on a magnetic disk of a remote computer. The remote computer can load the instructions for implementing all or a portion of the present disclosure remotely into a dynamic memory and send the instructions over a telephone line using a modem. A modem local to the computer system 1101 may receive the data on the telephone line and place the data on the bus 1102. The bus 1102 carries the data to the main memory 1104, from which the processor 1103 retrieves and executes the instructions. The instructions received by the main memory 1104 may optionally be stored on storage device 1107 or 1108 either before or after execution by processor 1103.

The computer system 1101 also includes a communication interface 1113 coupled to the bus 1102. The communication interface 1113 provides a two-way data communication coupling to a network link 1114 that is connected to, for example, a local area network (LAN) 1115, or to another communications network 1116 such as the Internet. For example, the communication interface 1113 may be a network interface card to attach to any packet switched LAN, As another example, the communication interface 1113 may be an integrated services digital network (ISDN) card. Wireless links may also be implemented. In any such implementation, the communication interface 1113 sends and receives electrical, electromagnetic or optical signals that carry digital data streams representing various types of information.

The network link 1114 typically provides data communication through one or more networks to other data devices. For example, the network link 1114 may provide a connection to another computer through a local network 1115 (e.g., a LAN) or through equipment operated by a service provider, which provides communication services through a communications network 1116. The local network 1114 and the communications network 1116 use, for example, electrical, electromagnetic, or optical signals that carry digital data streams, and the associated physical layer (e.g., CAT 5 cable, coaxial cable, optical fiber, etc.). The signals through the various networks and the signals on the network link 1114 and through the communication interface 1113, which carry the digital data to and from the computer system 1101, may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits, The digital data may also be used to modulate a carrier wave, such as with amplitude, phase and/or frequency shift keyed signals that are propagated over a conductive media, or transmitted as electromagnetic waves through a propagation medium. Thus, the digital data may be sent as un-modulated baseband data through a “wired” communication channel and/or sent within a predetermined frequency band, different than baseband, by modulating a carrier wave. The computer system 1101 can transmit and receive data, including program code, through the network(s) 1115 and 1116, the network link 1114 and the communication interface 1113. Moreover, the network link 1114 may provide a connection through a LAN 1115 to a mobile device 1117 such as a personal digital assistant (PDA) laptop computer, or cellular telephone.

While certain embodiments have been described, these embodiments have been presented by way of example only, and are not intended to limit the scope of the inventions. Indeed the novel methods and systems described herein may be embodied in a variety of other forms, such as an application executed on a mobile phone, tablet device or the like. Further, the E-check device can also be used at a pick up booth, curb side booth, a drive-in or the like at the restaurant. Specifically, the customer may place an order either by calling ahead of time or by using the Internet. The customer can then use the E-check device simply to make payments for the meal ordered.

Furthermore, the tax computation for a particular order may be performed by the restaurant processing server. The calculation logic for a particular check may be handled by a web service. Similarly, information of different cards for paying a bill using the split bill feature may be retrieved from a web based service. The list of shopping items added by the customer to his bill may also be processed by the service. In addition, the customer may have the provision to select the size and quantity of a shopping item and fulfill the billing and shipping address details. Alternatively, the customer may have the shopping item delivered to his table if there is sufficient inventory of that item in the restaurant.

The web based service can also be used to retrieve the amount of money available on a gift card that is used by the customer to pay for the services rendered. For example, on swiping the gift card, the web based service may return the value on the gift card and once the user enters the amount to be deducted, the service would take care of deducting that amount form the gift card, For printing receipts of the check, a request may be send to the web based service, which would communicate with the processing server and instruct the processing server to print a copy of the bill.

The E-check device can adhere to a Payment Card Industry Data Security Standard (PCI DSS) and implement a secure socket layer (SSL) encryption to ensure safety and privacy of the card information that is transmitted from the restaurant processing server to the web based server. Further, with regard to the electronic card reader of the E-check device, the associated software development kit (SDK) libraries can be invoked through a Foreign Function Interface (FFI) and can be configured to capture and encrypt credit/gift card details. Further, only the encrypted payment details such as total amount, card number, expiration date, card holder name or the like can he passed to a web based credit card service, where upon the credit card server would return a payment confirmation or error message.

Additionally, while using the E-check device for making a payment transaction, the customer may choose to make the payment by using a biometric E-payment method. Specifically, the customer can have the details of his/her card information linked to his/her unique biometric information. Thus, instead of manually swiping a credit or gift card, the customer may input his biometric information such as a finger print or the like into a biometric reader installed in the E-check device.

Furthermore, the E-check rewards card may be a mobile phone, a tablet device or the like, wherein an application installed or downloadable on the device may be configured to store or access all the rewards account information of the customer. The mobile phone, tablet device or the like may be provided by the restaurant customer instead of being provided by the restaurant. Furthermore, the application ay also be configured to communicate with the restaurant processing server by any of the communication means described herein. Furthermore, the application may be configured to display a wait time on a display panel of the mobile phone when a customer checks into the restaurant and there is a wait time for a table to become free. Additionally, a countdown timer can be displayed corresponding to the wait time. The device may be configured to provide a notification such as a vibration or a visual notification indicating the customer that a table is ready for him.

The application that the customer installs on his/her mobile phone or tablet device or the like may also be configured to communicate with the restaurant server during the meal so that the customer can notify the attendant via the application on the customer's personal device.

Similarly, the E-pager device can also be a mobile phone, tablet device or the like and may be configured to communicate with the restaurant processing server with the use of an application installed thereon. The application installed on such an E-pager (mobile phone) may be configured to notify the attendant, for example, if the meal order for a particular table is ready. Further, the application installed on the E-pager may also be configured to communicate with the customer (operating one of the E-check device or E-menu device), and notify the attendant of a successful payment transaction performed by the customer, indicate the attendant that the customer requires his service or the like.

Furthermore, the E-check device as describe herein can be used in a variety of businesses other than a restaurant business. For example, the E-check device can be used in a hotel wherein a customer may perform check-in or check-out process, pay for his stay at the hotel, and/or order room service and the like. Other businesses where the above described devices (and their corresponding methods of operation), can be used include bars, night-clubs, stadiums, arena's, shopping malls, airline industry, theatres, cruises or the like. The E-check device or the E-menu device can also be equipped with a camera thereby enabling the customer to take pictures and post the pictures of the restaurant, food or the like on his or her social media account or save or send the photographs via email or the like. Furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions.

1. A method of providing an enhanced dining experience by using an electronic device, the method comprising:
receiving a listing of charges for a user, the listing including a description of the charges;
determining suggested additional products for purchase;
displaying the suggested additional products to the user;
receiving a purchase selection of the additional products from the user;
updating the listing of charges based on the selected additional products;
displaying a plurality of options to pay for the charges;
receiving a selection of an option of the received plurality of payment options; and
transferring payment information from the electronic device to a processing server to complete a payment transaction.

2. The method according to claim 1, wherein the listing further includes a link to a detailed description of the charges.

3. The method according to claim 1, further comprising:
performing a login operation at the electronic device;
receiving a plurality of dining options available for ordering;
providing suggestions from the plurality of dining options based upon a user profile of the logged in user;
receiving a selection of a dining option from the user; and
transmitting the dining selection to a central server.

4. The method according to claim 3, further comprising:
receiving a selection of an attendant to serve the dining order.

5. The method according to claim 3, further comprising:
receiving an estimated wait time for delivering the transmitted dining selection.

6. The method of claim 1, wherein the suggested additional products for purchase include merchandise.

7. The method of claim 1, wherein the suggested additional products for purchase include any menu item.

8. The method of claim 1, further comprising:
offering the option of completing a survey after displaying the plurality of options to pay for the charges.

9. The method of claim further comprising:
transmitting a request for printing a receipt of the payment information.

10. The method of claim 1, further comprising:
transmitting, by a GPS transmitter, a location of the electronic device to the central server.

11. A method of providing an enhanced dining experience by a central server, the central server implementing the method comprising:
receiving login information from an electronic device;
obtaining profile information of a user based on the login information;
recommending meal preferences for he user based on the profile information;
receiving a dining order from the electronic device;
estimating a wait time for fulfillment of the dining order;
notifying an attendant to serve the dining order when it is ready;
providing a plurality of payment options to the electronic device; and
receiving and processing payment information trans tied from the electronic device.

12. The method of claim 10, further comprising:
determining whether the received dining order can be completed based on an inventory stock or whether the customized menu can be implemented; and
updating the inventory stock upon receiving the plurality of dining orders from the electronic devices.

13. The method of claim 10, further comprising:
offering products or services at a discounted rate in response to a wait time exceeding a predetermined threshold.

14. The method of claim 10, further comprising:
tracking the location of the electronic device.

15. The method of claim 10, further comprising:
providing a plurality of shopping items for electronic device;
transmitting a survey to the electronic device; and
providing a plurality of options for transmitting a receipt of the payment information.

16. The method of claim 10, further comprising:
storing dining order information in a memory; and
processing the stored information to determine popularity of a certain dining item.

17. An electronic device comprising:
a display panel configured to display information;
a payment reader configured to capture payment information;
an input element configured to receive user input;
a memory; and
a processor configured to implement:
a display unit configured to display on the display panel a login screen, a menu screen including ordering options, and a payment screen including payment options,
a reception unit configured to receive order information and receive input login information,
a payment unit configured to receive payment information captured by the payment reader, and
a transmission unit configured to transmit the received order information, the login information, and the payment information to a central server.

18. The electronic device according to claim 17, wherein the central server configured to:
verify login information received from the electronic device,
determine dining recommendations based on a user profile corresponding to the login information,
receive a dining order from the electronic device,
estimate a wait time for delivering the received dining order,
provide a plurality of payment options to the electronic device, and
receive payment information transmitted from each electronic device.
